(19) United States
(12) Patent Application Publication
(10) Pub. No.: US 2025/0390092 A1
(43) Pub. Date: Dec. 25, 2025

(54) HOUSEHOLD APPLIANCE AND QUALITY MANAGEMENT METHOD, DEVICE, CONTROL DEVICE AND SYSTEM FOR HOUSEHOLD APPLIANCES

(71) Applicant: BSH Hausgeräte GmbH, München (DE)

(72) Inventors: Sergio AGUADO MUNOZ, Ottobrunn (DE); Marek IMIALEK, München (DE)

(21) Appl. No.: 19/239,303

(22) Filed: Jun. 16, 2025

(30) Foreign Application Priority Data
Jun. 24, 2024 (EP) 24184027

(51) Int. Cl. G05B 23/02

(52) U.S. Cl. CPC G05B 23/0283; G05B 23/024

(57) ABSTRACT

A method for quality management for household appliances includes steps of collecting first data indicative of operation or usage of a plurality of household appliances of a predetermined type, and collecting second data indicative of malfunctions or service requirements of household appliances of that type. The first or second data of a household appliance are subjected to a filter that is configurable by a user associated with the household appliance, and machine learning is applied to relate the first data to the second data. A device, a control device and a system for quality management for household appliances are also provided.

### CROSS-REFERENCE TO RELATED APPLICATION

This application claims the priority, under 35 U.S.C. § 119, of European Patent Application EP 24184027, filed Jun. 24, 2024; the prior application is herewith incorporated by reference in its entirety.

### FIELD AND BACKGROUND OF THE INVENTION

The present invention relates to quality management of a household appliance. More specifically, the present invention relates to quality management for a fleet of household appliances.

A household appliance is adapted to be used in a household and may be electrically powered. The appliance is configured with a predetermined durability so that a user may enjoy its services. However, the appliance may malfunction or break down and it may be necessary to replace a part or perform a service to make it function properly again. For the user that may result in a period in which he or she cannot use the appliance. A service technician must be called, and a service must be scheduled, or the appliance must be turned in to a repair shop. Additionally, the service or repair generally costs money, which the user must invest to keep the appliance usable.

Proper product care or regular maintenance may significantly prolong product lifetime, reliability or quality of service. In some cases, it may be possible for the user to perform some actions that will make the appliance usable again. However, to a regular user it is not always clear what actions must be performed at what time in order to prevent a malfunction of the appliance.

European Patent EP 3 599 437 B1, corresponding to U.S. Pat. No. 11,391,510 B2, proposes a refrigerator and a cloud server detecting an abnormal state. Upon a malfunction of the refrigerator a remote service is contacted for guidance.

U.S. Publication No. 2022/364957 A1 proposes a system and method for cloud-based fault code diagnostics. That solution collects vast amounts of data, which are used for various purposes and distributed to different parties of interest.

### SUMMARY OF THE INVENTION

It is accordingly an object of the invention to provide a household appliance and a quality management method, device, control device and system for household appliances, which overcome the hereinafore-mentioned disadvantages of the heretofore-known methods, devices and systems of this general type and which provide an improved technique for maintaining a fleet of household appliances.

With the foregoing and other objects in view there is provided, in accordance with a first aspect of the present invention, a method for quality management for household appliances comprising the steps of collecting first data indicative of operation or usage of a plurality of household appliances of a predetermined type, collecting second data indicative of malfunctions or service requirements of household appliances of that type, the first or second data of a household appliance being subjected to a filter that is configurable by a user associated with the household appliance, and applying machine learning to relate the first data to the second data.

The dependent claims describe preferred embodiments.

In the present method, there is a consent given by the user to collect and analyze the data. Collected data may be used to train a machine, which implements machine learning. The machine may especially use an artificial intelligence (AI) technique and get trained on the basis of the data. The machine may for instance use or include an artificial neural network (ANN), which may include an input layer, an output layer and at least one hidden layer. Deep learning may be implemented on the machine. The machine may thus be able to identify and use patterns or relationships in the data. The trained machine may accept first data and produce (or generate) second data, wherein the first data may be different from any training data and produced (or generated) second data may still be related to the first data.

The household appliance may for instance include a kitchen appliance or a laundry treating appliance. As a kitchen appliance, the appliance may for instance include a blender, a dishwasher, a slicing machine, a cooking hood or a food processor. A laundry treating appliance may for example be a washing machine, a tumble dryer, a hot press, a flat iron, a steam iron or the like.

It is furthermore preferred that information indicative of a user associated with a household appliance is extracted from first and second data. The data may thus be anonymized and still permit statistical or AI processing. The data may be brought into a form where the user may not be deduced from the first or second data. A user may be informed on the way the collected data is processed and proof may be offered that inferring a person from collected data is practically impossible. One or more of various known anonymization techniques like hash tables or mathematical one way functions may be used to make sure personal data is never determined and never can be reconstructed from the collected data.

The above-described machine may be trained on the basis of anonymized household appliance fleet data to make predictions. In a preferred embodiment, the method may include a step of predicting an upcoming malfunction or service requirement in a household appliance on the basis of its operation or usage data. Such a prediction or forecast may be determined before trouble with the appliance arises and especially before a malfunction is detectable by a user. It is preferred that the first data is routinely forwarded for collection purposes. For each set of data—or less frequently, if desired—a probability for an upcoming malfunction may be determined. Practically, a user may trade appliance usage data for improved forecast data concerning possible upcoming difficulties in using the appliance.

The forecast may be made available to the user in regular intervals, if the forecast proves unfavorable or per user request. In one preferred embodiment, predictions are done on a regular basis and the user may be assured of the good working order of his or her household appliance. Should a possible upcoming problem be identified on the basis of the first data, a corresponding warning message may be provided to the user. Such message may be provided proactively, such as to inform the user only if need arises.

In this way, the user may be enabled to make a better decision on how to proceed with the appliance. If the appliance has served much of an expected lifetime, the user may decide to proceed to a more modern unit as soon as the present one fails. However, the user may also decide to stick with the existing machine and try and continue to enjoy its services for some more time.

In one embodiment, remaining usage information until a predicted malfunction is determined. This information may be communicated to the user, preferably after the remaining usage has dropped under a predetermined threshold, which may be user-configurable. The remaining usage may be expressed in use time, e.g. operation hours or overall time, including standby or off times. E.g. an exhaust hood may be forecast to be operable for some 60 more days, based on average daily usage, or 10 more net hours of operation. Usage may also be expressed in units of cycles or uses. For instance, a coffee machine may be estimated to be able to produce some 100 more cups of coffee before a heating element has lost too much of its heating power. A user may thus be able to make up his or her mind on how to proceed with the household appliance and take appropriate action.

Furthermore, a user intervention for preventing or delaying a predicted malfunction may be determined. Such action may lie in the range of skill of a typical user and may include actions like cleaning, descaling, replacing a user-accessible part or checking functionality of an element. Such actions may also help prolonging machine life of the appliance. It has been observed that regular service action is frequently not performed unless a user is specifically invited to do so. With the present invention, service procedures may be reduced to cases of actual necessity.

A service measure for preventing or delaying the predicted malfunction may be determined by using the trained machine. Such a service measure will generally be carried out not by the user but by a trained technician. The user may estimate the cost for the service measure, possibly including a price for a replacement part, auxiliary parts like seals or compensation for the technician. For instance, a part that is likely to break in the near or mid future may be replaced before malfunction is likely to occur. The user may be warned of the possible malfunction so that he or she may choose to book a technician to perform the service measure. Such action may be called preemptive maintenance. The appliance may have a lower overall downtime and a time where it is not available due to a service being carried out may be managed more conveniently.

The method may further include collecting third data indicative of service or repair applied to household appliances of that type, wherein prediction capabilities of the machine learning are verified or refined on the basis of the third data. A user intervention or a technician's service intervention may be noted and used to verify and/or improve prediction capabilities. A replaced part may be analyzed for actual damage. Actual appliance lifetime may be monitored and an effect of a service action on the lifetime may be monitored. Such checks may be used to further train the machine to further improve its relating or predicting capabilities.

According to yet another embodiment of the present invention, fourth data indicative of retired household appliances of that type is collected, and wherein an expected lifetime of that type of household appliance is determined. The fourth data, too, may be used to improve or check prediction capabilities of the trained machine. The remaining lifetime of household appliances of the same type may thus be determined better.

With the objects of the invention in view, there is also provided a device comprising a first interface for first data indicative of operation or usage of household appliances of a predetermined type, a second interface for second data indicative of malfunctions or service requirements of household applications of that type, and a processing unit that is adapted to apply machine learning to relate first data to second data. Such a device may be realized as a computer or other processing machine. The device may include a computer or a server or it may be realized as a service, for instance in a cloud environment. It is to be noted that anonymization of household appliance data as described herein may be done either on the user side or on the server side. The device may transform received first and second data into a form where inference of personal data is not possible, or this may be done by a different processing unit. In one embodiment, the anonymization may be done by the appliance or a controlling device. In another embodiment, anonymization may be done by storing facilities, which are adapted to accumulate and/or preserve collected first and/or second data. First and second data may be maintained by dedicated units or a combined unit.

With the objects of the invention in view, there is furthermore provided a control device for a household appliance comprising a sensor for determining operation or usage data of the household appliance, a communication interface, a user interface, a processing unit that is adapted to capture user input relating to a data filter, to collect first data indicative of operation or usage of the household appliance, to collect second data indicative of malfunctions or service requirements of the household appliance, to subject the data to the filter, and to provide the filtered data to an external unit. As has been mentioned herein, anonymization may be done here or in another device, especially the above-described processing device or a data maintenance or storage device.

The processing unit may be adapted to carry out, completely or in part, a method disclosed herein. The processing unit may be of an electronic nature and may include a micro computer or micro controller, an ASIC or a similar device. The method may be realized as a computer program product with program code and may be stored on a computer readable medium. Features or advantages of the method may be applicable to a corresponding device or system as well as vice versa.

With the objects of the invention in view, there is additionally provided a household appliance, which comprises a control device described herein. The household appliance is preferred to be an electric device and may especially include a kitchen appliance, a floor treating appliance, a cleaning device or a laundry treating appliance. Other household appliances like an electric tool are also possible.

With the objects of the invention in view, there is concomitantly provided a system comprising the above-described device and a plurality of above-described household appliances. It is especially preferred that the system includes a fleet of such household appliances. For instance, a producer of a certain type of household appliance may strive to use as many of the produced appliances as possible for providing data for a technique as described herein.

The system may be adapted to work with more than one type of household appliance. Data for one type of household appliance may be collected from the same or similar devices from only one or from different manufacturers.

E.g. data may be collected only from appliances of a predetermined type and brand. Data may be collected from the same type of appliance, but in different models or from different manufacturers. Data from different household appliances may also be collected.

A machine learning technique as described herein may exploit the fact that certain machine learning techniques may be good at accepting a large number of input data points and provide a comparatively tiny number of output parameters. This is especially true for ANNs, where there may be hundreds of thousands of input parameters and only one or two output parameters, as is custom e.g. in image recognition.

In the described system, each household appliance may be assigned a unique identification, and the processing unit of a household appliance is adapted to provide the data along with the identification. The appliance's control device may be adapted to provide the data along with the identification. The identification may help relating different data points to the same appliance. However, at the same time anonymization as proposed herein may ensure that there is no way from the data to an identification of a user associated with a household appliance, which provided the data.

Other features which are considered as characteristic for the invention are set forth in the appended claims.

Although the invention is illustrated and described herein as embodied in a household appliance and a quality management method, device, control device and system for household appliances, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a block diagram of a system; and

FIG. 2 is a flow diagram of a method.

### DETAILED DESCRIPTION OF THE INVENTION

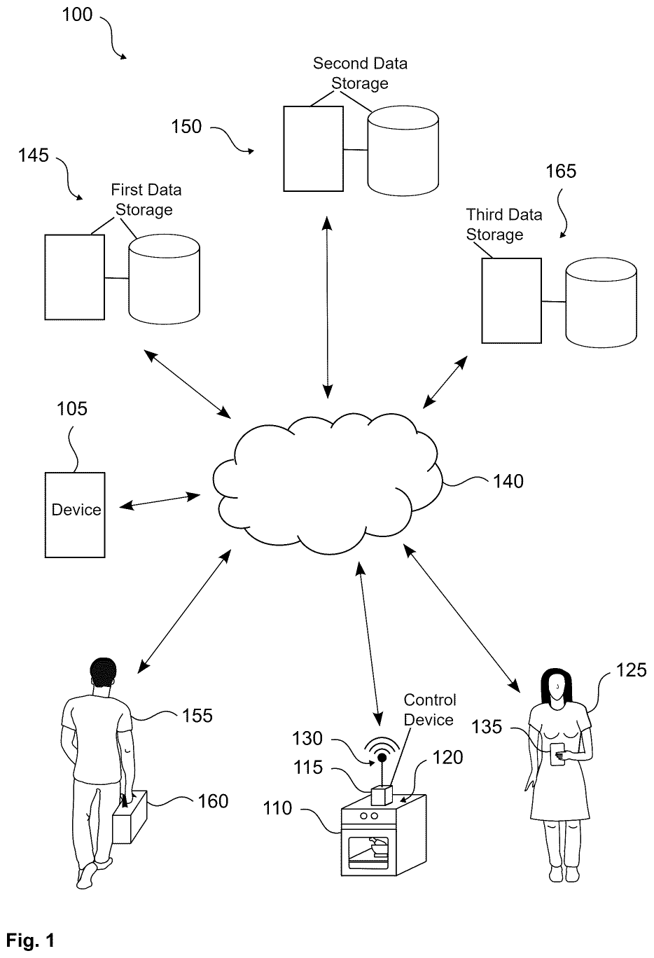

Referring now to the figures of the drawings in detail and first, particularly, to FIG. 1 thereof, there is seen an exemplary system 100. The system 100 includes a device 105 which may be trained on the basis of data that is collected from a plurality of household appliances 110. Such a household appliance 110 is preferred to be equipped with a control device 115 which includes a processing unit as well as one or more sensors 120 for picking up operation or usage data of an associated household appliance 110. A sensor 120 may be part of the household appliance 110 or shared with it.

Sensors 120 may register different values from different categories, like temperature, voltage, program running, phase of the program, step of the program, time remaining, program running, error code, etc. Such sensors 120 could also register more complicated data, as for example vibrations, sounds/noises or force or torque generated.

Exemplary sensors 120 may be adapted to determine on-times and off-times or include a temperature sensor, an electric voltage or current sensor, a pressure sensor, a light sensor or a similar sensor. The processing unit may also act as a sensor 120 and determine data on what process the appliance 110 was requested to carry out when and/or under which circumstances, etc. A process parameter or a control parameter may also be determined, including user settings and a progression of a processing parameter. Should the appliance for instance include a coffee maker then collected data may include information on which kind of coffee specialty was requested when, how much of it, how strong it was, how much water and coffee beans were used, how long it took, whether or not there were any problems encountered, what brewing temperature was used, how long it took to reach the brewing temperature, what water pressure could be achieved and so forth. More first data may include a counter value, e.g. how many coffees have been processed since the last service or how many times a coffee beans grinding mill had been used. It may also include a timer value like how long something took or how much time a certain part had been activated in a predetermined way. Generally, the first data may include any information on how the appliance 110 was used.

The household appliance 110 may be associated with a user 125, who may also be associated with a household. Other appliances 110 may be associated with that same household. The user 125 is a person that is in any way responsible for the appliance 110 and is especially the human that will be informed of health data determined for the household appliance 110. It is not strictly necessary that the user 125 actually uses or operates the household appliance 110; other persons in the household may do this instead or additionally.

The control device 115 includes a communication interface 130 for communicating with an external unit, and a user interface 135 for communicating with the user 125. In the present embodiment both interfaces may share certain elements. The interface 130 may for instance include a radio communication link like WLAN or Bluetooth and may communicate wirelessly with a hot spot which may interface wireless data with an optical or electric data network 140. The network 140 may include, for instance, a section of a mobile network or the internet.

The user interface 135 may be realized at the appliance 110, for instance in the form of buttons, screens or the like. In the present exemplary case the user interface 135 is realized on a mobile device accessible to the user 125, wherein the mobile device may be a smart phone, a tablet computer, a laptop computer or a similar type of device. The mobile device communicates with the control device 115 wirelessly over the interface 130 or a dedicated interface. The user interface 135 may be used to control the household appliance 110 and/or to set or edit a filter for the control device 115. The filter describes what kind of data the user 125 agrees to share with an external storage or service, especially with the central device 105. First data provided by the control device 115 may be associated with a unique identification for the appliance 110 or its type. The identification may include a predetermined number or alphanumeric string. As will be described in more detail below, the user interface 135 may also be used to convey external information to the user 125.

Collected first data from the sensors 120 may be subjected to the set filter. The filtered first data may be provided to a first data storage 145 which may be implemented as a remote server or a service, especially in a cloud. A second data storage 150 may be provided for trouble data with household appliances 110. The second data storage 150 may receive corresponding second data e.g. from repairs done by a technician 155, including spare parts 160 required during the repair, time needed and/or additional remarks from the technician 155. It can also be fed from an external knowledge database, a web page or forum containing information about typical problems with the appliance 110 and solutions or materials quality information. Second data may also be associated with a unique identification of the household appliance 110 to which it relates. It is preferred that the second data storage 150 uses the same kind of identification as the first data storage 145 so that first and second data may be related to each other via the identification of the household appliance 110.

First and second data may be forwarded to the device 105 where they can be processed. It is preferred that first and second data are structured such that automatic procession, especially in the context of machine learning is possible. For systematic information like the first data, a format may be given. For information derived from human experiences, discussion, estimation or insights, a human-understandable format may be acceptable. In one embodiment the device 105 is adapted to process natural language data and may for instance include a language model, especially a large language model (LLM).

The central device 105 may acquire first and second data from the data storage 145, 150 or directly from a household appliance 110 and process it. Processing is preferred to use methods of machine learning and especially of artificial intelligence. In one embodiment, an ANN is used. The device 105 processes the first and second data in order to find relationships between data points. Processing may include training the learning machine to relate the first data to the second data.

In other words, it is attempted to provide a trained machine which is able to accept usage or operation data concerning a household appliance 110 and determine possible trouble data which may relate to it. The machine 105 is preferred to also be able to determine if input first data has no relationship to any known second data. In this case, a household appliance 110 from which the first data is derived may be considered fully functional and not subject to functional problems.

Based on past training data, the device 105 may also determine a probability that a malfunction will happen in a predetermined future. For prediction, both statistical and AI techniques may be used. The future is preferred to lie in a predetermined range, say, between 1 and 30 days.

There may be provided a third data storage 165. The device 105 may match information from the first and second data storages 145, 150 and provide a prediction, based on appliance data and repair data, whether a malfunction of the household appliance 110 is to be expected. A confidence score may be provided which indicates a probability with which a predicted malfunction (or its absence) will be correct. The confidence score may be a function of time into the future. The third data storage 165 may use the anonymous single key which is able to match first and second data with each other or with a type of household appliance 110.

It is preferred that the device 105 will continually check and improve its prediction capabilities based on a stream of first and second data on operation and malfunction of household appliances 110. In this way the device 105 may host a continuously learning process which may continue to improve prediction capabilities. In this way, a number of false positive determinations of upcoming malfunction and/or a number of incorrect negative determinations of trouble-free operation may be reduced to a minimum.

A result of such determination may be relayed to the user 125. The result may be indicative of a possibly pending malfunction of the household appliance 110. The user 125 may be suggested to take action to service or replace the household appliance 110. The user 125 may be supplied with more detailed information like how much a service measure will cost him/her or what the chances are that a predicted behavior will prove true. There may also be an indication of what remaining use the household appliance is determined to be. This may be based on slowly deteriorating performance of the household appliance 110 or one of its parts. On the basis of such information, the user 125 may for instance decide to perform some-possibly suggested-service action on the household appliance 110, inform a technician 155, replace a part 160, ignore the prediction or scrap the household appliance 110 altogether. The device 105 may be adapted to provide information that will help the user 125 in this decision process.

It is to be understood that although the device 105 and the first, second and third data storages, stores or storage devices 145, 150, 165 are shown as separate entities, two or more of them may be integrated into one entity. In one embodiment, all four elements 105, 145, 150, 165 can be realized by one machine, server or service.

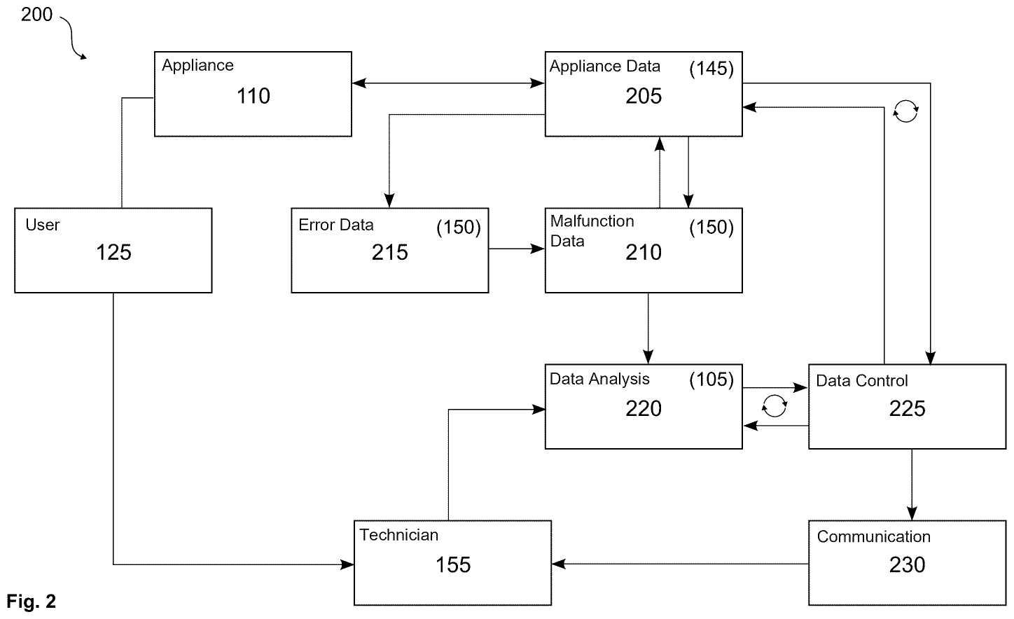

FIG. 2 shows steps of a method 200 for quality management for household appliances. Steps are shown as boxes, identified by reference signs. Additional reference signs in brackets denote items in the system 100 where the corresponding step takes place or where a data flow item is located. That is, appliance data will be generated at the appliance 110 and forwarded to the first data storage 145. Malfunction data 210 and error data 215 may be forwarded to second data storage 150. Data analysis may take place in a step 220 on the central device 105. Data control may be done in a step 225 and communication in a step 230. Besides this, FIG. 2 also shows the customer or user 125 and the repair service or technician 155. Circular arrows indicate ongoing updates.

In one exemplary walkthrough the following steps may be carried out:
1. The customer home appliance 110 registers the usage of data and forwards this information to the first data storage 145.
2. The first data storage 145 keeps the usage information from the appliance 110 for a predetermined period.
3. The second data storage 145 identifies an error generated by one specific appliance 110 and notifies this unexpected situation to the central device 105.
4. The second data storage 145 calls to the central device 105 and requests data of that appliance 110 before the error happened. Additional information may be drawn for appliances of the same or a similar type which are known to have suffered from a similar error.
5. The central device 105 generates historic information for each error and product. Thanks to this historical information, the device 105 can start to work to predict a future malfunction on the basis of an early indication that is detected in the usage or operation data. This observation may be based on statistical techniques.
6. The more historic information is used by the device 105, the more precise predictions may be generated.
7. The central device 105 may apply a machine-learning algorithm to improve the prediction, according to more and more data received on errors.
8. The central device 105 organizes all the data generated in a previous period for all appliances 110 for each specific error.
9. In a step 220, the central device 105 determines specific relationships between events, which happened in the periods analyzed and the error in question.
10. The central device 105 performs this analysis for each identified error.
11. The central device 105 learns from each generated set of data. It may apply a controlled machine learning technique to improve the prediction of errors.

In an illustrative example where the appliance 110 includes a coffee maker, the first information received related to an error in step 215 is that a water temperature internal to the appliance 110 drops from a normal 60° C. to only 30° C. Each time a coffee specialty is prepared, the temperature drops by another 2° C. Once the defect becomes manifest, a maximum of 15 use cycles remain before the temperature is so low that the coffee does not taste well any more.

The central device 105 determines this relationship and identifies a good time when the user 125 should be informed of the upcoming malfunction. In the present example, it could be determined that an alarm should be raised if the temperature falls to 46° C. With an observation of a temperature drop to this value, a confidence that the suspected error has befallen the appliance 110 may be 99%, while the confidence may be only 60% if the observed temperature drop is no larger than 60%. The prediction says that the appliance will be rendered unusable after 7 cycles.

The central device 105 manages all the predictions and updates the predictions if more information related to this prediction becomes apparent. Depending on a program running (for example, or an additional information from other sensors), the temperature may descend 3° C. or 1° C. during each cycle.

The cloud control of data 225 may check continuously if the predictions stored are up-to-date according to the data analysis 220 and if the data from the cloud appliance 205 identifies one appliance 110 as being affected by a prediction, checking the predictions one by one continuously. This may be done in parallel with more than one prediction at the same time.

A communication block 230 manages the communication to users 125 of appliances 110 or technicians 155. The communication block 230 manages the time and the frequency to communicate with a user 125. The user 125 may be allowed to adjust or personalize such communication. Once the user receives a warning that his or her appliance 110 may have only a limited time or number of operation cycles left to go, he or she may decide on how to proceed with the appliance 110.

In some embodiments, the communication block 230 may supply information on fixing options for the appliance 110. This may include usage advice or a simple service intervention that may be carried out by the user. A cost estimate for fixing the appliance 110 may be produced. Optionally, the user 125 may be offered help in finding or hiring a technician 155.

The following is a summary list of reference numerals and the corresponding structure used in the above description of the invention:
100 system
105 device (central)
110 household appliance
115 control device (at the appliance)
120 sensor
125 user/person responsible for the household appliance
130 communication interface
135 user interface
140 data network
145 first data storage (operation and usage)
150 second data storage (malfunction or service)
155 technician
160 spare part
165 third data storage (predicted events)
200 method
205 appliance data
210 malfunction data
215 error data
220 data analysis
225 data control
230 communication

1. A method, comprising steps of:
collecting first data indicative of operation or usage of a plurality of household appliances of a predetermined type;
collecting second data indicative of malfunctions or service requirements of household appliances of the predetermined type;
subjecting the first or second data of a household appliance to a filter configurable by a user associated with the household appliance; and
applying machine learning to relate the first data to the second data.

2. The method according to claim 1, which further comprises extracting information indicative of a user from the first and second data.

3. The method according to claim 1, which further comprises carrying out a step of predicting an upcoming malfunction or service requirement in a household appliance based on operation or usage data of the household appliance.

4. The method according to claim 3, which further comprises determining remaining usage information until a predicted malfunction.

5. The method according to claim 3, which further comprises determining a user intervention for preventing the predicted malfunction.

6. The method according to claim 3, which further comprises determining a service measure for preventing the predicted malfunction.

7. The method according to claim 1, which further comprises collecting third data indicative of service or repair applied to household appliances of the predetermined type, and verifying or refining prediction capabilities of the machine learning based on the third data.

8. The method according to claim 1, which further comprises collecting fourth data indicative of retired household appliances of the predetermined type, and determining an expected lifetime of the predetermined type of household appliance.

9. A device, comprising:
a first interface for first data indicative of operation or usage of household appliances of a predetermined type;
a second interface for second data indicative of malfunctions or service requirements of household applications of the predetermined type; and
a processing unit adapted to apply machine learning to relate the first data to the second data.

10. A control device for a household appliance, the control device comprising:
a sensor for determining operation or usage data of the household appliance;
a communication interface;
a user interface; and
a processing unit adapted:
to capture user input relating to a data filter;
to collect first data indicative of operation or usage of the household appliance;
to collect second data indicative of malfunctions or service requirements of the household appliance;
to subject the data to the filter; and
to provide filtered data to an external unit.

11. A household appliance, comprising a control device according to claim 10.

12. A system, comprising:
a device including:
a first interface for first data indicative of operation or usage of household appliances of a predetermined type;
a second interface for second data indicative of malfunctions or service requirements of household applications of the predetermined type; and
a processing unit adapted to apply machine learning to relate the first data to the second data; and
a plurality of household appliances according to claim 11.

13. The system according to claim 12, wherein each household appliance is assigned a unique identification, and the processing unit of a household appliance is adapted to provide the data along with the identification.
